(19) United States
(12) Patent Application Publication
(10) Pub. No.: US 2024/0179534 A1
(43) Pub. Date: May 30, 2024

(54) Filtering the access of a connected object to a local area communication network

(71) Applicant: ORANGE, Issy-les-Moulineaux (FR)

(72) Inventors: Eric Bouvet, CHÂTILLON CEDEX (FR); Fabrice Fontaine, CHÂTILLON CEDEX (FR)

(21) Appl. No.: 18/517,317

(22) Filed: Nov. 22, 2023

(30) Foreign Application Priority Data
Nov. 25, 2022 (FR) 2212365

(51) Int. Cl. H04W 12/60; H04L 9/40

(52) U.S. Cl. CPC H04W 12/66; H04L 63/0227; H04L 63/108; H04W 12/71

(57) ABSTRACT

A method for filtering access of a connected object to a local area communication network, implemented by a routing device of the local area network. The method includes: detecting a connected object waiting for pairing within the local network; assigning a confidence score to the connected object, based on information relating to the connected object; notifying a trusted device of the local area network of the request to pair the connected object and of the assigned confidence score; and upon receipt of a pairing refusal from the trusted device, blocking an access of the connected object to the local area network.

### CROSS-REFERENCE TO RELATED APPLICATION

This application claims the benefit of and priority to French Patent Application No. FR2212365, filed Nov. 25, 2022, the content of which is incorporated herein by reference in its entirety.

### TECHNICAL FIELD

The field of the present disclosure is that of local area communication networks, such as corporate communication networks or home communication networks. More specifically, the present disclosure relates to the interaction, with such local area communication networks, of communicating or connected, or IoT (Internet of Things) objects such as computers, tablets and smartphones, but also webcams, weather stations, sensors, thermostats, drones, smoke sensors, connected light bulbs, etc.

### PRIOR ART

Connected objects such as these are invading the daily lives of users or companies. Although these objects provide users with access to interesting new services, they also increase the weaknesses of the communications networks they are integrated in, by increasing the exposition of these networks to potential malicious individuals or systems.

One of the key moments when a local area communication network is vulnerable is when a new connected object is paired with this local area network, particularly when it uses a wireless communications technology such as Wi-Fi® or the communication protocol defined in the IEEE 802.15.4 standard, also known as “Thread”.

Indeed, during this pairing step, the user sends to the new connected object the information it needs to connect to the local area communication network and to the Internet wide area communication network to which it provides access. This information includes, for example:
the name of the local area communication network (or SSID for “Service Set IDentifier” in the case of a Wi-Fi® network) and the password to access this network;
some items of information linked to the user's account (for example, the identifier of their Google®, Amazon® or Apple® account);
some items of technical information, such as the time configuration, a private cryptographic key or an operational security certificate, as proposed in the Matter® connectivity protocol supported by the “Connectivity Standards Alliance” (CSA) group of companies.

This is the principle, for example, of the AllJoyn® protocol, which offers an “Onboarding Service” for a new device to easily join an existing WiFi® communication network, as illustrated in relation to FIG. 1.

A communicating, or IoT, object 11 is considered, in this case a connected light bulb, for example from the LIFX® brand. A local area communication network, for example a home network, can be accessed via a home gateway (HGW) 10. This network can comprise various communicating objects or devices, such as a laptop, a tablet and a smartphone 12.

According to the AllJoyn® “Onboarding Service”, a device wishing to pair with this local area communication network must publish a network, that is create a WiFi® access point, whose SSID (Service Set Identifier, in accordance with the IEEE 802.11 standard) contains an AJ_ prefix or an _AJ suffix. This access point can be secure or open. This corresponds to a preliminary step E1, not shown in FIG. 1. For example, the connected light bulb 11 publishes a “Lifi-A0_AJ” WiFi® network.

At the same time, a user must launch, for example using their smartphone 12, an application dedicated to the “onboarding” service. When this application is launched, the smartphone 12 deactivates the WiFi® connection to the home gateway HGW 10 (step E2) in order to listen to communicating objects waiting for pairing. During a step E3, it connects to the access point created by the connected light bulb 11, and sends to it the data it needs to pair with the home gateway HGW 10, namely a WiFi® key and the gateway password. For example, this data is entered by the user on the communication interface of the smartphone 12. It may also have been previously stored in this device. These AllJoyn® exchanges are encrypted, but not authenticated.

Upon receipt, the connected light bulb 11 can, during a step E4, connect to the home gateway HGW 10, using this pairing data.

At the end of this pairing phase, the smartphone 12 can then disconnect from the “Lifi-A0_AJ” WiFi® network to reconnect to the local area communication network of the home gateway HGW 10.

This solution requires the user to actively launch the “Onboarding Service” application in order to authorise their smartphone to scan any AllJoyn® networks and turn off the WiFi® connection to the home gateway.

It is not very secure, insofar as it does not check the authenticity of the communicating object to be paired: there is therefore a risk that the mobile phone 12 will transmit the confidential pairing data to a malicious communicating object.

More generally, and irrespective of the implementation of the AllJoyn® protocol or any other alternative connection protocol, this pairing step is essential, as it may jeopardise the user's privacy and/or the security of their local area communication network, for two main reasons:
on the one hand, if this pairing step fails to secure the exchanges, sensitive data and information may be transmitted in clear text between the user and the connected object. They may therefore be easily accessible to a malicious third party, that can use them for fraudulent purposes;
on the other hand, even if this pairing step is carried out correctly, in compliance with strict confidentiality rules, the existence of vulnerabilities or security breaches in the connected object can also make this sensitive data accessible to a malicious third party.

Indeed, some connected objects have a low level of security, or send the user's data to third-party platforms without their consent.

To date, the pairing procedure recommended by connected object manufacturers generally does not include any security measures: users are simply invited to download the connected object manufacturer's application to their smartphone or tablet, and to follow the proposed pairing procedure, which consists in a direct exchange of various data between the connected object and the user's terminal.

The main reasons for this lack of security measures are twofold: on the one hand, the manufacturers generally consider that the connected objects they market and the pairing application they offer do not present any security problem or lack of respect for the user's privacy; if such problems exist, they usually are unaware of them. On the other hand, manufacturers generally want to keep their ecosystem under control, i.e. all the connected objects and devices they market and that communicate with each other, and they are reluctant to involve a third-party security mechanism or device.

There is therefore a need for a technique for securing the pairing of a connected object with a local area communication network, which makes it possible to strengthen the security of the local area communication network, whatever the possible vulnerabilities of the connected object, and to respect the privacy of the network users and the confidentiality of their personal information. In particular, there is a need for such a technique to filter the access of connected objects to a local area communication network, depending on their potential vulnerabilities. There is also a need for such a technique that can easily be implemented with the deployment of the Matter® standard. There is still a need for such a technique that has a lower impact on the user experience than existing solutions.

Finally, there is a need for such a technique that enables connected objects to be connected to a secure ecosystem, such as that of the local area communication network access provider.

It will be noted that ecosystem refers here and in the remainder of this document to a set of devices that share common security and/or privacy and/or eco-design parameters, and that are capable of communicating with each other.

Throughout this document, pairing a connected object refers both to pairing the object to a local area communication network (to communicate with the other devices of the local area network or with the Internet wide area network), and requesting a commissioning in an application ecosystem (for example a “Fabric” according to the Matter® protocol).

### SUMMARY

An exemplary aspect of the present disclosure responds to this need by proposing a method for filtering the access of a connected object to a local area communication network, implemented by a routing device of the local area network, that comprises steps of:
detecting a connected object waiting for pairing within the local area network;
assigning a confidence score to the connected object, based on information relating to the connected object;
notifying at least one trusted device of the local area network of the request to pair the connected object and of the assigned confidence score;
upon receipt of a pairing refusal from the trusted device, blocking the access of the connected object to the local area network.

Thus, an aspect of the present disclosure is based on a completely new and inventive approach to pairing a connected object with a local area communication network.

An aspect of the present disclosure proposes, on the one hand, to involve a routing device of the local area network in the pairing procedure which, according to the prior art, is set up directly between the connected object and the user's terminal, and on the other hand, to assign a confidence score to the connected object, so that the user can make an informed choice about authorising this connected object to access the network.

Such an intelligent network access filtering mechanism has the advantage of being easy to implement with the deployment of the Matter® standard, which standardises pairing commands. It is recalled that Matter® is designed to connect IPV6 devices using the Ethernet, Wi-Fi® or Thread® protocols at the link layer.

In addition, this solution has no impact on the user experience, but enhances their privacy as well as the security of their network, by blocking the access of a potentially dangerous device to the network.

It can also be implemented quickly: as soon as it detects the presence of a connected object waiting for pairing, the routing device can carry out the various steps, faster than the time it takes for a user to download the connected object manufacturer's application to their smartphone or tablet and launch a conventional direct pairing procedure. It is therefore ensured that the routing device can implement this secure pairing procedure, instead of the conventional pairing procedure proposed by the IoT manufacturer.

In addition, the routing device can advantageously support several communication protocols (Wi-Fi®, Bluetooth®, Ethernet, etc.), and therefore detect the pairing attempt of a new IoT, regardless of the communication protocol it uses.

According to a first characteristic of the disclosure, the information relating to the connected object is received from the connected object and/or obtained by the routing device upon a request sent to a remote server.

Indeed, some of the information can be received directly from the connected object by the routing device, as it is transmitted by the connected object as part of its pairing attempt. Other information can be retrieved by the routing device at the IP (Internet Protocol) level, for example from a certificate present on a Web server, which may contain interesting information about the connected object, useful for deciding the confidence score to assign to it.

For example, such information relating to the connected object belongs to the group comprising:
a MAC address of the connected object;
a power of a signal received from the connected object;
a connection identifier of the connected object;
a product identifier of the connected object;
a manufacturer identifier of the connected object;
a validity period of a security certificate associated with the connected object;
a security level of a security certificate associated with the connected object;
an identifier of the organisation that issued a security certificate associated with the connected object.

According to another characteristic of the disclosure, the confidence score assigned results from an aggregation of at least some of the elements belonging to the group comprising:
a vulnerability score of the connected object;
a respect for user privacy score of the connected object;
an eco-design score of the connected object.

The assigned confidence score can take into account the evaluation of various aspects of the connected object's strengths and weaknesses, in terms of security and resistance to malicious attacks, respect for user privacy, but also in terms of impact of the connected object on the environment.

Other aspects could also be taken into account, such as the manufacturer's corporate social responsibility, etc.

However, to make it easier for the user to decide whether or not to block the access of the connected object to the network, it is advantageous for the various evaluations taken into account to be aggregated into a single confidence score, transmitted to the user's trusted device. This confidence score can, for example, take a value chosen from the triplet “good, average, bad”, or a colour chosen from the “green, yellow, red” palette. The user can therefore quickly make a decision, informed by this simple and accessible confidence score, as to whether or not to accept the pairing of the connected object to their local area communication network.

According to one aspect, the trusted device that is notified of the pairing request is the trusted device closest to the connected object and/or a trusted device belonging to an administrator of the local area network.

For example, the trusted device closest to the connected object is identified based on the RSSI (Received Signal Strength Indicator). It is indeed particularly convenient for the user to receive the pairing request on a device close to the connected object they are installing, and which is very likely to be their personal smartphone.

As a variant, the pairing request is notified to a trusted device of the network administrator, for example the parents in the case of a home network, who can thus control the installation of new connected objects by the children, and oppose them if necessary.

According to an optional variant, such an access filtering method also comprises:
transmitting, to the trusted device, a request to obtain a code associated with the connected object;
connecting the routing device, based on the code obtained from the trusted device, to the connected object, in order to obtain information relating to the connected object.

For example, the request to obtain a code is a request to scan a QR code associated with the connected object, and the scanned QR code is received by the routing device from the trusted device.

This advantageously ensures that the user of the trusted device is located near the connected object, and further strengthens the pairing security by preventing a malicious third party outside the local area communication network from remotely taking control of a connected object. For example, in the case of a camera installed in Alice's home, a malicious neighbour, Bob, is prevented from detecting the presence of the camera, pairing it with his own network and seeing what is happening in Alice's home without being authorised to do so.

According to another optional variant, once the connected object has been paired with the routing device of the local area communication network, it comprises sending to the trusted device a request to pair the connected object with the trusted device, and in case a request to pair with the trusted device is received, sending to the connected object a request to initiate a pairing sequence.

Thus, once the connected object has been paired to the local area communication network (and therefore the object is connected to an ecosystem of which the routing device is part of, e.g. that of the operator or the access provider), the routing device can ask the user if they want this connected object to join other ecosystems (for example, that of the manufacturer or the vendor of the connected object).

This solution enables users to use their connected objects in several secure environments: for example, that of their access provider, but also possibly that of third parties. This prevents connected objects from being locked into a single ecosystem.

In this case, as an option, if the connected object paired to the routing device is unable to be paired with the trusted device too, the routing device acts as a proxy server between the trusted device and the connected object.

This is advantageous in the case of a connected object that, because of its communication protocol, can only pair with one single ecosystem at a time, because this proxy role played by the routing device enables this limitation to be circumvented. The trusted device then connects to the routing device, thinking that it is the connected object, and the routing device acts as a transparent intermediary between the IoT and the trusted device.

According to an advantageous aspect, the routing device is a gateway for accessing the local area communication network. The access provider, which owns the gateway, can therefore remain an intermediary between its customer and the various connected objects they use.

An aspect of the present disclosure also relates to a computer program product comprising program code instructions for implementing an access filtering method as described previously, when it is executed by a processor.

An aspect of the present disclosure also relates to a computer-readable storage medium on which is saved a computer program comprising program code instructions for implementing the steps of the access filtering method according to an exemplary aspect as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to an exemplary aspect of the present disclosure can be downloaded in particular on a network, for example the Internet network.

Alternatively, the storage medium can be an integrated circuit in which the program is embedded, the circuit being adapted to execute or to be used in the execution of the above-mentioned access filtering method.

An aspect of the present disclosure further relates to a routing device of a local area communication network that comprises a processor configured to perform steps of:
detecting a connected object waiting for pairing within the local area network;
assigning a confidence score to the connected object, based on information relating to the connected object;
notifying a trusted device of the local area network of the request to pair the connected object and of the assigned confidence score;
upon receipt of a pairing refusal from the trusted device, blocking an access of the connected object to the local area network.

An aspect of the present disclosure further relates to a home gateway that comprises a processor configured to perform steps of:
detecting a connected object waiting for pairing within the local area network;
assigning a confidence score to the connected object, based on information relating to the connected object;
notifying a trusted device of the local area network of the request to pair the connected object and of the assigned confidence score;
upon receipt of a pairing refusal from the trusted device, blocking an access of the connected object to the local area network.

The above-mentioned corresponding routing device, access gateway and computer program have at least the same advantages as those provided by the access filtering method according to one or more an aspects of the present disclosure.

### PRESENTATION OF THE FIGURES

Other purposes, features and advantages of aspects of the present disclosure will become more apparent upon reading the following description, hereby given to serve as an illustrative and non-restrictive example, in relation to the figures, among which:

FIG. 1 illustrates a method for pairing a communicating object with a local area communication network, implementing the AllJoyn® Onboarding service of the prior art;

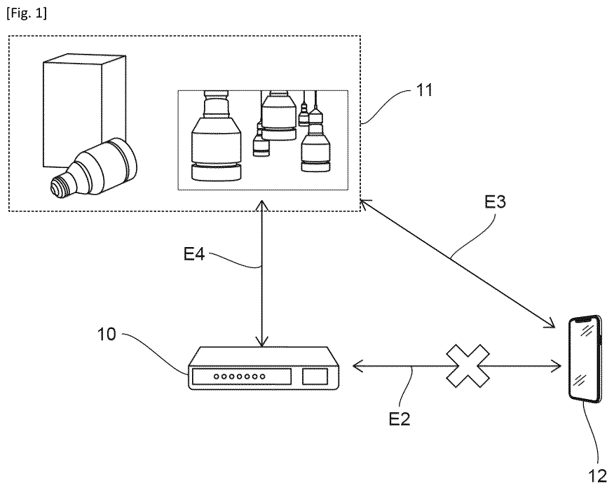

FIG. 2 shows a schematic view of a local area communication network and the various communicating objects connected to it, according to one aspect of the present disclosure;

FIG. 3 shows in the form of a flowchart the various steps of an access filtering method according to one aspect of the present disclosure;

FIG. 4 shows a synoptic diagram of a routing device implementing the method of FIG. 3.

### DETAILED DESCRIPTION OF ILLUSTRATIVE ASPECTS OF THE DISCLOSURE

The general principle of an aspect of the present disclosure is based on filtering the access of a connected object to a local area communication network by a routing device of this network, depending on a user decision based on a confidence score assigned to the connected object by the routing device.

The remainder of this document will focus more specifically on the implementation of one aspect of the present disclosure in the context of a home network, in the home of a private user, in which various devices form a star network around a central point, namely an access gateway, for example the Orange® Livebox®. Of course, the disclosure also applies to any other type of local area communication network (LAN), to which a plurality of communication devices are connected.

In particular, such a local area network could have a Thread® type mesh network structure, using a wireless radio protocol alternative to Wi-Fi®. It is recalled that Thread® technology is similar to Zigbee® technology, but offers better performance in terms of energy consumption, is more resilient and also easier to extend. In such a network, the access gateway, for example the Orange® Livebox®, can act as a Thread® routing device. What will be described below in the particular embodiment of a star network organised around an access gateway can easily be extended to any other type of local area network, and in particular a Thread® mesh network, in which the various steps of the access filtering method according to the disclosure are implemented by any of the routing devices of the local area network.

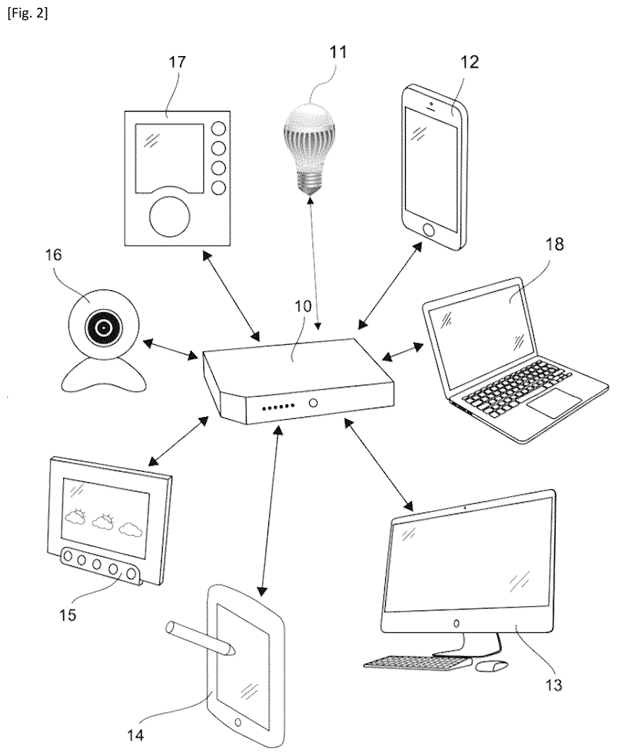

In the home network shown diagrammatically in FIG. 2, a home gateway HGW referenced 10 connects a local area communication network and a wide area network such as the Internet (not shown). Such a home gateway HGW 10 incorporates a DHCP server: it routes data packets on the network, and can also act as a firewall, a proxy . . .

In the example shown in FIG. 2, many devices are present on the local network, namely:
a connected light bulb 11;
a smartphone 12;
a PC computer 13;
a tablet 14;
a weather station 15;
a webcam 16;
a thermostat 17;
a laptop 18.

This list is not exhaustive, of course, and many other communicating objects may be present on the user's local area network. These communicating objects can be connected to the network by wire (Ethernet cable, USB (Universal Serial Bus) port, etc.) or wirelessly (Wi-Fi®, Bluetooth®, Zigbee®). They comprise all types of physical objects capable of communicating digitally on the local area network, with a view to exchanging data, and compatible with the DHCP network. They also comprise software applications associated with certain non-IP (Internet Protocol) connected objects, running on wireless technologies such as BLE (for “Bluetooth® Low Energy”), Z-wave®, Thread®, etc.

Such communicating objects can be referred to by the acronym IoT (Internet of Things).

More details are set forth hereafter about the attempt to pair these communicating objects on the user's local area communication network, for example using the WiFi® wireless radio transmission protocol.

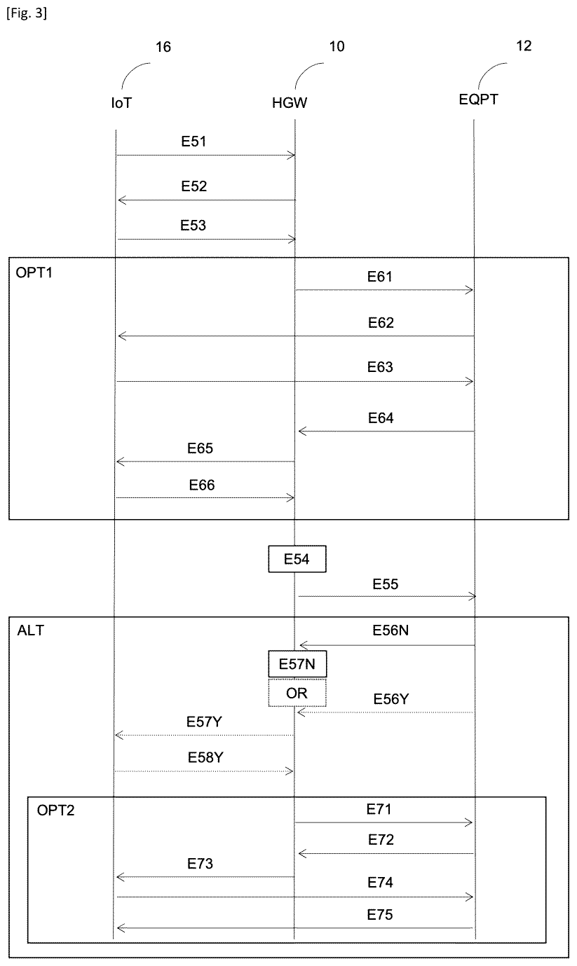

In relation to FIG. 3, the various steps of the method for filtering the access of an IoT connected object referenced 16 (for example, the webcam of FIG. 2) to a local area communication network according to one aspect of the present disclosure.

In this example, it is considered that this method is implemented in an access gateway HGW referenced 10, for example an Orange® Livebox®.

Attention is focused on the arrival of the IoT connected object referenced 16 in the local area network. When it is switched on, this connected object 16 goes into pairing mode, and sends pairing requests to its surroundings, which may be carried, depending on the communication protocol embedded in the IoT 16, by a Wi-Fi®, Bluetooth® or Ethernet communication technology, for example. This advertising phase is show in FIG. 3 by the step referenced E51.

The home gateway HGW 10 continuously detects (step referenced E52) the objects around it. In particular, it can detect objects in pairing mode:
at Wi-Fi® level (for example, in the Matter® standard, objects in pairing mode open a Matter-xxx open access point; in the proprietary Tuya® protocol, objects open a SmartLife-xxx access point);
at Bluetooth® level (for example, the object referenced 16 sends advertising packets with a specific name, such as DCS-xxx for D-Link® cameras);
at Ethernet level (for example, in the Matter standard, objects will send specific mDNS requests).

During a step referenced E53, the gateway HGW 10 retrieves information about the IoT object referenced 16 (for example at Wi-Fi radio level: @MAC, SSID name, signal strength, etc.). In addition, the gateway HGW 10 can also retrieve information at IP level, if it is able to connect to the object.

This information can, for example, be retrieved from a certificate on a Web server. This certificate may contain information of interest such as a product identifier of the connected object 16, a vendor identifier of the connected object 16, the name of the organisation that issued this certificate, a validity period, a security level . . .

This information about the IoT connected object referenced 16 can thus be retrieved directly from the object itself, or obtained from local and/or external sources. Using the information collected in this way, the gateway HGW 10 calculates, during a step referenced E54, a confidence score to be assigned to the object referenced 16.

To do this, it can in particular query remote or local databases to check whether the manufacturer of the connected object 16, or the certificate associated with it, is “secure”:
has the certificate been revoked (in particular, is it present in one or more certificate revocation lists (CRLs), i.e. a list of digital certificates that have been revoked by the issuing certification authority before their scheduled expiry date and must no longer be trusted)?
is the certificate valid (for example, by querying the Matter® Distributed Compliance Ledger (DCL))?

The DCL Matter is a cryptographically secured distributed storage network based on blockchain technology. It enables the Connectivity Standards Alliance (CSA) and authorised vendors to publish information about their Matter® devices. This information can then be retrieved using DCL clients.

With all this device information stored in the DCL, Matter® ecosystems can check the DCL to verify the compliance status of the device certification, or for example to obtain commissioning instructions, links to manuals and product information.
Does the product have any known public vulnerabilities (CVE, for “Common Vulnerabilities and Exposures”, which is a dictionary of public information relating to security vulnerabilities, maintained by the MITRE organisation, supported by the US Department of Homeland Security)?
Does the manufacturer have a physical presence in Europe (which may be an interesting guarantee of compliance with the General Data Protection Regulation (GDPR), Regulation UE 2016/679 of the European Parliament and of the Council of 27 Apr. 2016 on the protection of individuals with regard to the processing of personal data and on the free movement of such data);
etc.

The gateway HGW 10 can also collect information about the methods used to manufacture the connected object 16: does it meet certain eco-design standards? Does its manufacturer have a corporate social responsibility policy in place? What is its carbon footprint?

Depending on the information received, the gateway HGW 10 assigns a confidence score to the connected object referenced 16, which can for example take a value chosen from the triplet (low, medium, high) or a colour chosen from the palette (red, yellow, green). This confidence score aggregates, for example in the form of a weighted average, the various scores obtained by the IoT connected object 16 in terms of security, respect for privacy, eco-design, etc.

During a step referenced E55, the gateway HGW 10 transmits this confidence score to at least one trusted device EQPT referenced 12, for example the smartphone of the user who switched on the connected object 16, and/or that of the local area network administrator, or an Orange TV set-top box. In the following, for purposes of simplification, a single trusted device EQPT referenced 12 will be mentioned; however, all the information below can be directly extended to the case where the access gateway HGW referenced 10 communicates with several distinct trusted devices.

This confidence score is transmitted in a notification that also contains a request for the user to accept or not the connection of this new object 16 to their local area network. This notification can also contain a request for the user, to know whether they want this object 16 to join the Orange trusted ecosystem (“Fabric” in the Matter® standard; in this standard, the term “Fabric” refers to a logical collection of communicating nodes, sharing a common trusted root and a common distributed configuration state). This notification or “targeted advertising” (step E55) can be sent to the trusted terminal(s) closest to the referenced IoT connected object 16 (for example using the RSSI, that is the strength of the signal received from the IoT object 16) or to the one of the network administrators, for example the “parents” in the case of a home network. The notification may contain a link to an Orange application and/or detailed information about the detected object referenced 16.

Depending on the decision made by the user of the trusted device referenced 12, two situations may arise (reference ALT in FIG. 3).

The user may decide, on the basis of the notification received in step referenced E55 and the confidence score it contains, to refuse pairing this new connected object with their local area network, because they consider it cannot be trusted sufficiently. In this case, the trusted device EQPT referenced 12 sends to the gateway HGW 10 a refusal notification during a step referenced E56N.

This is particularly likely to be the case if the confidence score assigned by the access gateway HGW referenced 10 is “bad” or “red”, but also, if the user is cautious, in the case where the confidence score is “medium” or “yellow” too.

During a step referenced E57N, the gateway HGW 10 then blocks the access of the IoT object referenced 16 to the local area communication network, or isolates the latter. To do this, the gateway HGW 10 can set up firewall rules using the IP address, or block the Wi-Fi connection using the MAC address, or not respond to DNS (Domain Name Server) requests, etc.

Alternatively, the user may decide, on the basis of the notification received in step referenced E55 and the confidence score it contains, to accept pairing this new connected object to their local area network, as they consider it can be trusted sufficiently. In this case, the trusted device EQPT referenced 12 sends to the gateway HGW 10 an acceptance notification during a step referenced E56Y.

This will likely be the case if the confidence score received is “good” or “green”; it may also be the case if the confidence score received is “amber” or “medium”, and the user so decides.

During a step referenced E57Y, the access gateway HGW 10 then sends to the connected object 16 all the configuration parameters it needs to connect to the local area network, such as the SSID, the network password, data relating to the Orange® ecosystem “Fabric”, etc. During a step referenced E58Y, the IoT connected object referenced 16 can then connect to the gateway HGW 10 and access all the resources of the local area network and the Orange® ecosystem “Fabric”.

Two optional variants, OPT1 and OPT2, which can be implemented together or independently of each other, are also shown in FIG. 3.

The variant referenced OPT1 comprises a set of steps referenced E61 to E66 and is intended to increase the reliability of the confidence score assignment to the connected object 16. To do this, during a step referenced E61, the gateway HGW 10 sends to the trusted device EQPT referenced 12 a code entry notification. For example, the gateway HGW 10 can ask the user to scan a QR code on the connected object referenced 16, or to manually enter a code that will allow the gateway HGW 10 to connect to the connected object referenced 16 in order to retrieve a certificate (for example, the “Device Attestation Certificate” in the Matter® standard).

There are several advantages to using a QR code. First of all, this step imposed to the user enables them to check that they are in the vicinity of the IoT connected object referenced 16. In addition, this QR code can contain a various useful information, such as the Matter® certificate, but also the various advertising channels (Wi-Fi®, Bluetooth®, etc.) embedded in the IoT connected object.

Thus, during a step referenced E62, the user uses the trusted device EQPT referenced 12 to scan the QR code on the IoT connected object referenced 16. The information it contains is transmitted to the trusted device EQPT referenced 12 during a step referenced E63, then transferred during a step referenced E64 to the access gateway HGW referenced 10.

According to the Matter® standard, this QR code printed on the IoT connected object referenced 16 enables the user to obtain all the information needed to configure the device. The QR code contains a base38-encoded binary code including the values:
Version
Vendor ID
Product ID
Custom flow
Discovery capabilities
Discriminator
Access code
Jam
TLV data (optional) (used to configure the custom flow).

During a step referenced E65, the access gateway HGW referenced 10 uses the QR code received to connect to the IoT connected object referenced 16. During a step referenced E66, the IoT connected object referenced 16 transmits advanced information to the access gateway HGW referenced 10, for example the Matter® certificate.

The variant referenced OPT2, that may or may not be combined with the variant referenced OPT1, comprises a set of steps referenced E71 to E75 and is intended to extend the pairing of the IoT connected object referenced 16 to several ecosystems.

Indeed, once the IoT connected object referenced 16 is connected to the Orange® ecosystem (or “Fabric” in the Matter® standard), the access gateway HGW referenced 10 can ask the user if they want this object referenced 16 to join other ecosystems or “Fabrics” (e.g. that of Amazon®, Google®, Apple®, etc.). It is recalled the Matter® treats networks as shared resources: it does not state exclusive ownership of or access to networks. As a result, it is possible to run several Matter networks, called “fabrics”, on the same set of constituent networks.

Thus, during a step referenced E71, the access gateway HGW referenced 10 sends to the trusted device EQPT referenced 12 a notification asking it whether a connection to a third-party ecosystem is desired.

In the event of a positive response from the trusted device EQPT referenced 12 during a step referenced E72, the access gateway HGW referenced 10 sends (step referenced E73), to the IoT connected object referenced 16, a request to initiate a new pairing procedure (for example, using the “Basic Commissioning Method” or “Enhanced Commissioning Method” procedure in Matter®). During a step referenced E74, the IoT connected object referenced 16 then launches a new advertising phase (in Wi-Fi®, Bluetooth®, etc. depending on the communication channels available to it), to the trusted device EQPT referenced 12. During a step referenced E75, the latter sends in return the configuration parameters required to join the chosen third-party ecosystem, for example the Amazon® Fabric.

It will be noted that, in the context of this variant OPT2, if the IoT connected object referenced 16 is unable to initiate a new pairing procedure (e.g. because its proprietary protocol does not allow it to do so, for example the Tuya® protocol), the access gateway HGW referenced 10 can simulate the IoT connected object referenced 16 to the trusted device EQPT referenced 12, and act as a proxy server between these two devices.

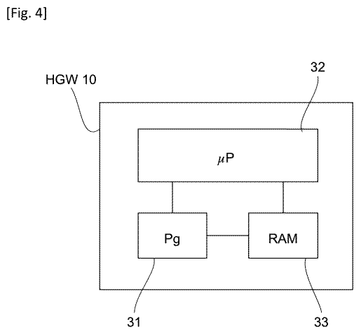

In relation to FIG. 4, the hardware structure of a routing device, for example a home gateway HGW referenced 10, implementing the steps of the flowchart of FIG. 3, in any of its embodiments, is now presented.

Such a home gateway HGW 10 comprises a random access memory 33 (a RAM memory, for example), a processing unit 32 equipped for example with a processor and controlled by a computer program stored in a read-only memory 31 (a ROM memory or hard disk, for example). At initialisation, the code instructions of the computer program are for example loaded into a random access memory 33 before being executed by the processor of the processing unit 32.

The term “unit” can correspond to a software component as well as to a hardware component or a set of hardware and software components, a software component itself corresponding to one or more computer programs or sub-programs, or more generally, to any element of a program capable of implementing a function or set of functions.

The random access memory 33 notably contains the information collected relating to the connected object referenced 16 during step E53, as well as the various parameters required to calculate the confidence score, and the calculated confidence score itself. The processor of the processing unit 32 controls the transmission and reception of the various notifications addressed to the trusted device EQPT referenced 12 and to the connected IoT object referenced 16 according to the flowchart of FIG. 3, as well as the calculation of the confidence score during the step referenced E54.

FIG. 4 only shows a particular one of several possible ways of realising the home gateway HGW 10, so that it executes the steps of the method detailed above, in relation to FIG. 3 (in any of the various embodiments, or in a combination of these embodiments). Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the home gateway HGW 10 is realised with a reprogrammable computing machine, the corresponding program (that is, the sequence of instructions) can be stored in a removable (such as, for example floppy disk, CD-ROM or DVD-ROM) or non-removable storage medium, this storage medium being partially or totally readable by a computer or a processor.

The various embodiments have been described above in relation to a Livebox® home gateway, but can more generally be implemented in any gateway, router or access point (Wi-Fi® repeater, 4G access point . . . ).

What is claimed is:

1. An access filtering method for filtering access of a connected object to a local area communication network, implemented by a routing device of said local area network, wherein the method comprises:
detecting a connected object waiting for pairing within said local area network;
assigning a confidence score to said connected object, based on information relating to said connected object;
notifying at least one trusted device of said local network of the request to pair said connected object and of said assigned confidence score; and
upon receipt of a pairing refusal from said at least one trusted device, blocking an access of said connected object to said local area network.

2. The access filtering method according to claim 1, wherein said information relating to said connected object is received from said connected object and/or obtained by said routing device upon a request sent to a remote server.

3. The access filtering method according to claim 1, wherein said information relating to said connected object belongs to the group consisting of:
a MAC address of said connected object;
a power of a signal received from said connected object;
a connection identifier of said connected object;
a product identifier of said connected object;
a manufacturer identifier of said connected object;
a validity period of a security certificate associated with said connected object;
a security level of a security certificate associated with said connected object;
an identifier of an organisation that issued a security certificate associated with said connected object.

4. The access filtering method according to claim 1, wherein said assigned confidence score results from an aggregation of at least some of elements belonging to the group consisting of:
a vulnerability score of said connected object;
a respect for user privacy score of said connected object;
an eco-design score of said connected object.

5. The access filtering method according to claim 1, wherein said at least one trusted device that is notified of said pairing request is said trusted device closest to said connected object or a trusted device belonging to an administrator of said local area network.

6. The access filtering method according to claim 1, wherein the method also comprises:
transmitting, to said at least one trusted device, a request to obtain a code associated with said connected object;
connecting said routing device, based on said code obtained from said at least one trusted device, to said connected object, in order to obtain said information relating to said connected object.

7. The access filtering method according to claim 6, wherein said request to obtain a code is a request to scan a Quick-Response (QR) code associated with said connected object, and wherein the scanned QR code is received by said routing device from said at least one trusted device.

8. The access filtering method according to claim 1, wherein the method also comprises, once said connected object has been paired with said routing device of said local area communication network, transmitting, to said at least one trusted device, a request to pair said connected object to said at least one trusted device, and in case a pairing request with said at least one trusted device is received, transmitting, to said connected object, a request to initiate a pairing sequence.

9. The access filtering method according to claim 8, wherein, in response to said connected object paired with said routing device being unable to be paired with said at least one trusted device too, said routing device acts as a proxy server between said at least one trusted device and said connected object.

10. The access filtering method according to claim 1, wherein said routing device is a gateway to access said local area communication network.

11. A non-transitory computer readable medium comprising program code instructions stored thereon for implementing an access filtering method for filtering access of a connected object to a local area communication network, when the instructions are executed by a processor of a routing device of said local area network, wherein the method comprises:
detecting a connected object waiting for pairing within said local area network;
assigning a confidence score to said connected object, based on information relating to said connected object;
notifying at least one trusted device of said local network of the request to pair said connected object and of said assigned confidence score; and
upon receipt of a pairing refusal from said at least one trusted device, blocking an access of said connected object to said local area network.

12. A routing device of a local area communication network, wherein the routing device comprises:
a processor configured to:
detect a connected object waiting for pairing within said local network;
assign a confidence score to said connected object, based on information relating to said connected object;
notify at least one trusted device of said local area network of the request to pair said connected object and of said assigned confidence score; and
upon receipt of a pairing refusal from said at least one trusted device, block an access of said connected object to said local area network.

13. The routing device according to claim 12, wherein the routing device is a gateway to access said local area communication network.
